(19) United States
(12) Patent Application Publication
(10) Pub. No.: US 2005/0060377 A1
(43) Pub. Date: Mar. 17, 2005

(54) Transitory messaging with location information

(76) Inventors: Chen Chien Lo, Portland, OR (US); James R. Trethewey, Hillsboro, OR (US); Manoj Agnihotri, Lake Oswego, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/661,279

(22) Filed: Sep. 12, 2003

(51) Int. Cl. G06F 15/16

(52) U.S. Cl. 709/206

(57) ABSTRACT

Instant messaging clients provide location information in conjunction with registering their presence with an instant messaging server. The location information may be propagated to other instant messaging clients as well as to other commercial services, such as advertisers, and non-commercial services, so that actions can be taken with respect to locations of the instant messaging clients.

### FIELD OF THE INVENTION

The invention generally relates to location aware computing, and more particularly to utilizing client location information in an instant messaging environment.

### BACKGROUND

Microsoft Corporation of Redmond Wash., AOL Time Warner Inc (AOL) of New York, and other corporations offer instant messaging, or simply “IM”, environments in which an IM Client may engage in live messaging with other IM Clients. Typically, instant messages can only be to other IM clients that are available on a network, e.g., client not in communication with the network cannot receive messages. Accordingly, “Buddy Lists” may be utilized to monitor when other specified users/clients (“buddies”) associate themselves with the network. Typically, an IM Client establishes a connection to a network and registers its presence with an IM server. The IM server notifies all other clients that have listed the just-registered IM Client in their Buddy Lists. This allows the other IM Clients to track when a particular IM Client is in contact with the network, and thus allow messages to be exchanged there between.

### BRIEF DESCRIPTION OF THE DRAWINGS

The features and advantages of the present invention will become apparent from the following detailed description of the present invention in which:

FIG. 1 illustrates a system according to one embodiment.

FIG. 2 illustrates an exemplary dataflow according to one embodiment along a time line illustrating communication between Instant Messaging Clients and an Instant Messaging Server.

FIG. 3 illustrates a suitable computing environment in which certain aspects of the invention may be implemented.

### DETAILED DESCRIPTION

Regarding terminology used in the following detailed description, attention is directed to utilization of “Instant Messaging” or “IM” technology. An instant message is a form of electronic communication between users of a computer network in which a window typically appears on a recipient's computer display “instantly” and without the recipient having to access an e-mail program or other message checking application. An instant message essentially appears immediately after a message sender decides to send the message, subject to data propagation delays within a network. IM versus e-mail is analogous to the distinction between engaging in a real-time telephone call versus engaging in a written exchange of letters via a U.S. Post Office.

In the following description, the phrases “instant messaging” and “Internet Chat application,” and the term “IM,” are all intended to generally reference real-time messaging environments and application programs, including instant messaging services, data transfer, and chat applications provided by Microsoft, AOL, and others. It will be understood by one skilled in the art that the following description is intended to encompass traditional IM environments utilizing a central IM server, as well as decentralized messaging models. For example, an IM variation may be employed in a peer-to-peer (P2P) context, where a single central IM server is not used, and instead multiple localized IM servers are used which exchange presence information. Alternatively, central servers may not be employed at all, and instead a virtual IM server may be implemented in a peer-to-peer environment in which peers propagate presence information between the peers according to a presence sharing protocol. It will be appreciated IM Clients communicate by way of wired and/or wireless technologies.

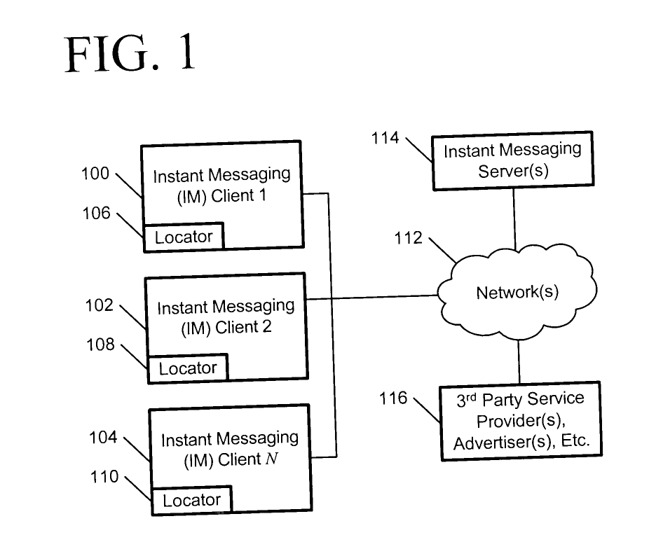

FIG. 1 illustrates a system according to one embodiment. Illustrated are one or more instant messaging (IM) clients 100-104. An IM Client may be implemented in hardware, software or combination thereof. A typical implementation is as a software service operating in the background in conjunction with an operating system; however, other embodiments may be employed.

Respectively disposed within each IM Client is a Locator 106-110 corresponding to location sensing technology operable to discern and provide a current location to the IM Client, e.g., to an application program, operating system component, or other aspect of the IM Client desiring to know the current location. It will be appreciated Locators 106-110 may employ various techniques and technologies to determine the current location, including GPS (Global Positioning System) or NAVSTAR (Navigation System with Timing and Ranging) technology; triangulation based on known RF (radio frequency) or data tower positions, e.g., cellular towers, radio or television station transmitters, wireless network hotspots, etc.; or querying a hotspot (e.g., IEEE (Institute of Electrical and Electronics Engineers) 802.11 based), network access point (AP) or other device, for its position, etc. Note that even though the Locators are illustrated within IM Clients, it will be appreciated Locators may be separate communicatively coupled devices, e.g., they may be a separate GPS receiver (e.g., standalone, in an automobile, etc.) communicating with the IM Client over a cable, e.g., serial, USB (Universal Serial Bus), etc., or other wired or wireless medium.

The IM Client(s) 100-104 are presumed in communication over a network 112 with at least one Instant Messaging Server (IMS) 114, which as discussed above, may be a central server utilized by the IM Clients to track each other's presence information, a distributed collection of Instant Messaging Servers (IMSs) each handling local IM Clients, or a virtualized IMS based on peer-to-peer sharing of presence information. For clarity in presentation, a single central IMS 114 as illustrated is presumed. Assuming each IM Client has each other in a “Buddy List,” as with a conventional IM environment, as each IM Client associates itself with the network, the other IM Clients are notified by the IMS that a “buddy” has become available.

However, in contrast with a conventional IM environment, when an IM Client 100-104 registers itself with the IMS 114, in addition to identifying itself to the IMS, IM Clients may elect to provide location information to the IMS. In the illustrated embodiment, this location information is determined by IM Client Locators 106-110. It will be appreciated location information may be encoded in a wide variety of formats, including altitude, latitude, and/or longitude coordinates, street address, map coordinates, database index, etc. In one embodiment, an IM Client's location is automatically provided to the IMS. In one embodiment, local policies and/or rules may be employed to control dissemination of location information. In a further embodiment, policies or rules may regulate specificity of location information, e.g., other IM Clients may be classified into categories (not illustrated) and the IM Client may instruct the IMS to provide certain clients with differing levels of detail regarding the IM Client's location.

Thus, for example, if IM Client 1 (100) is already connected to the IMS and IM Client 2 (102) connects to the IMS and provides its location, this location information be provided to IM Client 1 along with notification that IM Client 1's buddy is now available. IM Client 1 may then use the provided location information of IM Client 2 to take some action, such as display notifications to a user of IM Client 1, display special icons to the user, or to provide some other feedback or information to the user regarding the location of IM Client 1.

For example, different icons can be associated with IM Clients, where the icon can represent proximity between one client and its buddies, building location, or geographic position, e.g., the icon may be a flag or symbol for a state, country, or other locale. The term “icon” is intended to generally reference some technique to indicate a status, where the technique may be determined with respect to a particular technology used to interface with a user. For example, a two-dimensional (2D) graphic image may be used on a conventional 2D display, while a three-dimensional (3D) object may be utilized in a 3D virtual reality (VR) environment. Displayed icons for an IM Client may change through interaction with the IM Client, as well as based on changes in an IM Client's location. For example, an initial icon may be displayed for another IM Client to indicate whether the IM Client is online, or offline, and when online status is determined, a new icon (“emoticon”) may be displayed to indicate a mood for the IM Client. This icon may then change again to indicate that the IM Client is now physically nearby.

Or, for example, an “Internet Chat” application program may be configured with a user interface (UI) providing a “Coffee Break” button in the UI that automatically invites all proximate online buddies to take a coffee break. It will be appreciated proximity may be determined automatically and/or arbitrarily set by a user, e.g., a user may define proximity to mean buddies in the same building, within 100 meters, etc. Or, for example, IM Client location information can be used to display a graphic map illustrating the relative locations of all IM Clients, or of some subset of clients, such as clients within a particular chat session. It will be appreciated that the icon, UI button, and map examples are simply a few of a near infinite number of possible actions and activities that may be taken with respect to known locations of various IM Clients.

Alternatively, or in addition to activity taken by IM Clients with respect to location provided information, 3^{rd} party service providers 116, advertisers, etc. may also be provided with the location information allowing the providers, advertisers, etc. to make offers to IM Clients based on their locations. For example, an advertising based revenue model may be employed where advertising revenue support costs inherent to providing an IM environment, e.g., to support a chat service by charging providers for the IMS providing location information. Thus, when IM Clients provide their location, providers 116 may craft special offers, such as a “buy three lunches get one free” offer from a store that determines it is proximate to several IM Clients.

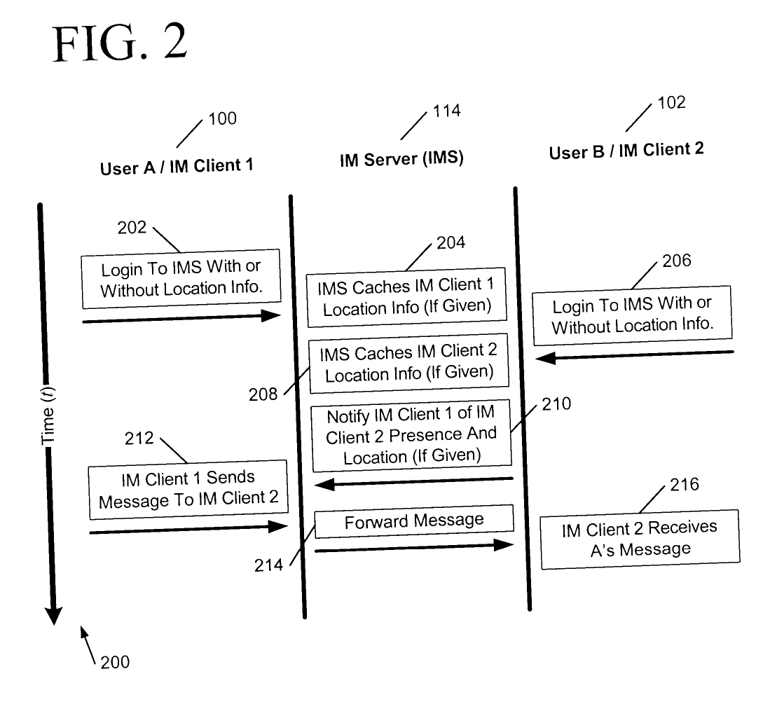

FIG. 2 illustrates an exemplary dataflow according to one embodiment along a time line 200 illustrating communication between two FIG. 1 IM Clients 100, 102 and an IM Server 114. Note that various illustrated operations may be independent of each other, and therefore may occur simultaneously or in a different order than shown.

User “A” of IM Client 1 100 logs in 202 to the IMS with or without (recall, it's optional) its current location information. The IMS caches 204 the location information, if given by IM Client 1. Assume location information is provided and cached. Similarly, User “B” of IM Client 2 102 logs in 206 to the IMS with or without its current location information, and the IMS caches 208 the location information. The IMS may then notify 210 IM Client 1 of IM Client 2's presence and location information. Similarly, although not illustrated, after establishing a connection with the IMS, the IMS will inform IM Client 2 of IM Client 1's presence and location information.

Now that IM Client 1 100 is aware of IM Client 2 102, IM Client 1 may then send 212 a message or other data, request, command, etc., to IM Client 2. As discussed above, the message or other data may be determined by or include the location information provided by the IMS for IM Client 2. The message or other data is received from IM Client 1 and forwarded by the IMS 114 to IM Client 2. When IM Client 2 102 receives IM Client 1's message or other data, IM Client 2 may then take appropriate action, e.g., display a message, alter an icon, activate an application, etc.

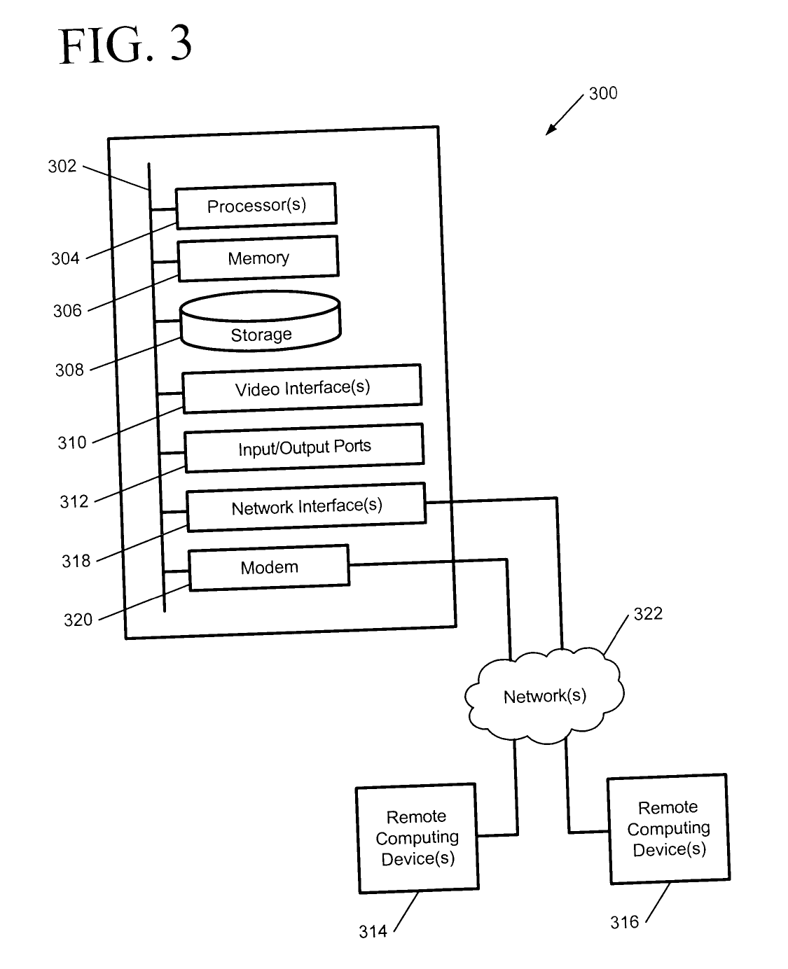

FIG. 3 and the following discussion are intended to provide a brief, general description of a suitable environment in which certain aspects of the illustrated invention may be implemented. As used herein below, the term “machine” is intended to broadly encompass a single machine, or a system of communicatively coupled machines or devices operating together. Exemplary machines include computing devices such as personal computers, workstations, servers, portable computers, handheld devices, e.g., Personal Digital Assistant (PDA), telephone, tablets, etc., as well as transportation devices, such as private or public transportation, e.g., automobiles, trains, cabs, etc.

Typically, the environment includes a machine 300 that includes a system bus 302 to which is attached processors 304, a memory 306, e.g., random access memory (RAM), read-only memory (ROM), or other state preserving medium, storage devices 308, a video interface 310, and input/output interface ports 312. The machine may be controlled, at least in part, by input from conventional input devices, such as keyboards, mice, etc., as well as by directives received from another machine, interaction with a virtual reality (VR) environment, biometric feedback, or other input source or signal.

The machine may include embedded controllers, such as programmable or non-programmable logic devices or arrays, Application Specific Integrated Circuits, embedded computers, smart cards, and the like. The machine may utilize one or more connections to one or more remote machines 314, 316, such as through a network interface 318, modem 320, or other communicative coupling. Machines may be interconnected by way of a physical and/or logical network 322, such as the network(s) 112 of FIG. 1, an intranet, the Internet, local area networks, and wide area networks. As discussed above with respect to the FIG. 1 network 112, one skilled in the art will appreciate communication with network 322 may utilize various wired and/or wireless short range or long range carriers and protocols, including radio frequency (RF), satellite, microwave, IEEE 802.11, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, volatile and/or non-volatile memory 306, or in storage devices 308 and their associated storage media, including hard-drives, floppy-disks, optical storage, tapes, flash memory, memory sticks, digital video disks, biological storage, etc. Associated data may be delivered over transmission environments, including network 322, in the form of packets, serial data, parallel data, propagated signals, etc., and may be used in a compressed or encrypted format. Associated data may be used in a distributed environment, and stored locally and/or remotely for access by single or multi-processor machines.

Thus, for example, with respect to the illustrated embodiments, assuming machine 300 embodies the FIG. 1 Instant Messaging (IM) Server 114 of FIG. 1, remote machines 314, 316 may then respectively be FIG. 1 IM Clients 1 100 and IM Client 2 102. It will be appreciated that remote machines 314, 316 may be configured like machine 300, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

1. A method for distributing data to at least a selected one of a plurality of potential instant message clients, the method comprising:
transmitting an identifier of a first client to an instant messaging server coordinating communication with at least the selected instant message client;
determining a first location for the first client; and
transmitting the first location for the first client to the instant messaging server.

2. The method of claim 1, further comprising:
receiving an advertisement from the instant messaging server responsive to transmitting the first location.

3. The method of claim 1, further comprising:
receiving from the instant messaging server a second location for the selected instant messaging client.

4. The method of claim 3, further comprising:
selecting an application program for execution based at least in part on the second location.

5. The method of claim 3, further comprising:
displaying an initial icon indicating an initial status of the selected instant messaging client; and
displaying a revised icon corresponding to the second location.

6. The method of claim 5, wherein the initial icon is a selected one of: an offline indicator, an online indicator, and an emoticon.

7. The method of claim 5, wherein the revised icon is a selected one of: a country identifier, a state identifier, a government seal, a flag, a building identifier, and a user identifier.

8. The method of claim 3, wherein the revised icon comprises a proximity map including a marker identifying the relative position of the second location to the first location when the second location is proximate to the first location.

9. The method of claim 8, wherein the marker is a selected one of: a country identifier, a state identifier, a government seal, a flag, a building identifier, and a user identifier.

10. A method for distributing data to at least a selected one of a plurality of potential instant message clients, the method comprising:
receiving an identifier of a first client by an instant messaging server coordinating communication with at least the selected instant message client; and
receiving a first location for the first client.

11. The method of claim 10, further comprising:
transmitting an advertisement to the first client responsive to receiving the first location.

12. The method of claim 10, further comprising:
transmitting the first location to an advertisement server;
receiving an advertisement from the advertisement server, the advertisement determined based at least in part on the first location; and
transmitting the advertisement to the first client.

13. The method of claim 10, further comprising:
receiving from the selected instant message client a second location for the selected instant messaging client.

14. The method of claim 13, further comprising:
transmitting the second location to the first client.

15. An article comprising a machine-accessible media having associated data for distributing data to at least a selected one of a plurality of potential instant message clients, wherein the data, when accessed, results in a machine performing:
transmitting an identifier of a first client to an instant messaging server coordinating communication with at least the selected instant message client;
determining a first location for the first client; and
transmitting the first location for the first client to the instant messaging server.

16. The article of claim 15 wherein the machine-accessible media further includes data, when accessed, results in the machine performing:
receiving an advertisement from the instant messaging server responsive to transmitting the first location.

17. The article of claim 15 wherein the machine-accessible media further includes data, when accessed, results in the machine performing:
receiving from the instant messaging server a second location for the selected instant messaging client.

18. An article comprising a machine-accessible media having associated data for distributing data to at least a selected one of a plurality of potential instant message clients, wherein the data, when accessed, results in a machine performing:
receiving an identifier of a first client by an instant messaging server coordinating communication with at least the selected instant message client; and
receiving a first location for the first client.

19. The article of claim 18 wherein the machine-accessible media further includes data, when accessed, results in the machine performing:
transmitting an advertisement to the first client responsive to receiving the first location.

20. The article of claim 18 wherein the machine-accessible media further includes data, when accessed, results in the machine performing:
transmitting the first location to an advertisement server;
receiving an advertisement from the advertisement server, the advertisement determined based at least in part on the first location; and
transmitting the advertisement to the first client.

21. The article of claim 18 wherein the machine-accessible media further includes data, when accessed, results in the machine performing:
receiving from the selected instant message client a second location for the selected instant messaging client.

22. A system, comprising:
an instant messaging server;
a first instant messaging client communicatively coupled with the instant messaging server, wherein the first instant messaging client is configured to provide a first location for the first instant messaging client to the instant messaging server;
a second instant messaging client communicatively coupled with the first instant messaging client and the instant messaging server, wherein the second instant messaging client is configured to provide a second location for the second instant messaging client to the instant messaging server.

23. The system of claim 22, further comprising:
an advertisement server communicatively coupled with at least the instant messaging server, wherein the advertisement server is configured to provide an advertisement determined based at least in part on instant message client locations provided to the advertisement server by the instant messaging server.
